(19) United States
(12) Patent Application Publication
(10) Pub. No.: US 2002/0194063 A1
(43) Pub. Date: Dec. 19, 2002

(54) Method for providing continuity of consumer purchase discounts

(76) Inventors: David B. Learner, Essex, CT (US); Douglas A. Learner, Essex, CT (US)

Correspondence Address: BIERMAN MUSERLIAN AND LUCAS, 600 THIRD AVENUE, NEW YORK, NY, 10016

(21) Appl. No.: 09/869,929

(22) PCT Filed: Mar. 16, 2001
(86) PCT No.: PCT/US01/08736

(51) Int. Cl. G06F 17/60

(52) U.S. Cl. 705/14

(57) ABSTRACT

The supplier issues a vehicle, including a coupon kit or a value card, for discounts on its products. The value card is sent to selected high volume retail customers who present the card to a retail establishment. The cards, which are preferably electronically or bar encoded, are read by the establishment which credits the customer with the appropriate discount or provides the product or service at no cost to the customer. The amount, in whole or part is paid by the supplier, either directly or indirectly through an intermediary. The coupon kit, and preferably the value card, is directed to a particular single branded service or product of the supplier. A plurality of discounts is provided to reinforce the retail customer to focus on the brand originating with the supplier.

The present Invention is directed to a method whereby a supplier of services or products can provide discounts directly to the ultimate consumer; more particularly, it is an interactive means whereby direct contact between a remote supplier and selected ultimate consumers can be made and maintained.

### BACKGROUND OF THE INVENTION

In the early 1890's, a Southern druggist distributed a coupon entitling his customers to a free glass of Coca-Cola. During the last century, this form of consumer incentive has grown to about 250 billion coupons annually in the U.S. alone. Over the years, the process has changed little; some sort of paper coupon embodying a discount is tendered and redeemed. The consumer burden of clipping, saving, and sorting coupons is one reason less than 2% of those 250 billion coupons are redeemed each year. The back office effort in counting, verifying, validating, and paying is a time consuming and costly task. While electronic transactions are now processed for pennies, coupon handling and processing cost as much as ten times that amount.

Many suppliers are spaced apart from the ultimate purchasers of their products or services; at minimum, a retail establishment intervenes. Often, there are distributors, jobbers, etc., each of which is in the distribution chain and distances the supplier from the customer it is intending to reach. Under known marketing systems, suppliers have limited opportunity, other than by the use of mass media, to build a relationship directly with the high volume customers in particular. This will determine the long term success or failure of their products.

Moreover, they also have limited control over the consumer's access to the products, nor do they have great influence over the degree of promotion which will be provided by (for example) the retail establishments. An example of this is the fierce competition for shelf space in supermarkets.

One approach has been the provision of incentive discount coupons, issued by the supplier, which the consumer can take to the retail establishment in order to receive a discount on the merchandise purchased. These coupons are first redeemed by the retail establishment which is reimbursed therefor by the supplier. However, such a system presents certain drawbacks.

Experience has shown that at least 98% of the coupons are lost or discarded without being used. Furthermore, even if the coupon is actually redeemed, it is for a single purchase only of branded goods and virtually no long term continuing impact benefiting the supplier results. Hence, opportunities for enhancing a bond between the supplier and customer are lost. On behalf of the supplier, there is a need for a system whereby the supplier can cumulatively reinforce the customer's relationship directly and, preferably, do so over a substantial period of time without excessive cost, thus creating a greater degree of brand loyalty on the part of the consumers. It is well recognized that, for a given product or category thereof, many competing brands are offered. Hence, it is particularly desirable for a supplier to be successful in linking a customer (especially a high volume one) to its particular brand of services or products.

### SUMMARY OF THE INVENTION

It is, therefore, a purpose of the present Invention to provide a method whereby a supplier of branded services or goods can maintain direct contact with the ultimate purchaser, even though one or more establishments (e.g. jobbers, distributors, wholesalers, retail establishments, etc.) intervene. In accordance with the present Invention, discounts can be provided to the retail customer in a manner best calculated both to reinforce a strong and lasting relationship with the brand of the supplier and to provide an increase in the sales revenue. In a preferred form of the method, means are provided whereby useful data as to the nature of the consumers purchasing behavior can be provided to the supplier in order to assist in targeting the most valuable customers. For example, the dates, outlet, frequency, volume, and prices paid by a given customer can be captured and this information returned to the supplier for further assistance in marketing.

In accordance with the present Invention, the supplier issues a vehicle, such as a value card or coupon kit, for multiple discounts. There are certain customers who purchase high volumes of a specific service or product and such purchases are distributed among a variety of brands thereof. The discount vehicles are concentrated on these customers to provide discounts (including free merchandise) and are solely for use for the issuing supplier's brand of the service or product. In this way, the high volume customer is encouraged to focus on the supplier's brand, whereby the supplier captures a large share of that customer's product or service purchases. The discounts are obtained when the customer presents the vehicles to a retail store.

If the vehicle consists of a coupon kit, there is a plurality of coupons therein which is directed to a single service or product under the brand of the supplier. Preferably, there will be no limitation on the time within which these coupons can be used. The purpose of doing so is to encourage the customer to concentrate on purchasing the supplier's brand of services or products and allows the customer to deal with any retail establishment. The multiplicity of coupons will constitute substantial pressure on the customer to focus on the desired brand.

As an example, if it is determined that a particular customer or household is purchasing 200 units per year of a product (albeit under different brand labels), by supplying the customer with perhaps 200 coupons directed to a specific brand of the supplier, the customer can increase the amount of that brand purchased up to (for example) 200 units. In this way, the multiple coupons are directed to the heavy service or product purchasers, who are the ones most likely to improve the issuing brand supplier's sales. Moreover, the group of coupons may be limited to a single brand and not directed to any other brand of the same supplier. The reason is that, if the customer is a high volume purchaser of product A, that does not mean that he or she is also a high volume purchaser of product B, even though the two originate with the same company. However, multibrand value cards or coupons may be issued to those who are high volume purchasers of more than one brand from the same supplier.

In the case of value cards, which are electronically, bar, or otherwise coded, they are read by the establishment which credits the customer with one appropriate discount for each unit purchase.

The card may be limited in time (in which case the customer may use it as often as desired during the allotted period), or it may be limited in amount or number of items.

In a preferred form of the value card, a plurality of discounts is provided on a single such card directed to a single brand service or product of the supplier. The customer is encouraged to retain the value card over its entire life so that the supplier's name is brought to the customer's attention many times, thus reinforcing the purchase decision.

From the foregoing, it can be seen that the present invention enables the remote supplier to forge a direct relationship with the ultimate consumer, by coupon kits and/or value cards. This will create good will for the supplier in the minds of the customers, which may be further reinforced through co-promotions by the particular outlet at which the customer shops. Not only is the impact direct, but also it reinforces continuity which is sustained over a substantial period of time, thus insuring a continued impression on the customer. All of this can be accomplished without the necessity of multiple advertisements, free standing insertions, or the like. Thus, by means of the present Invention, the supplier is able to generate maximum purchase frequency and consumer retention with a minimum of expense.

In this context, the multiple use incentive vehicles are a reward, direct from the supplier to selected high volume buyers. It is intended to increase the brands' share of those customers' product purchase volumes, especially through product purchase discounts applied frequently and continuously over extended time. This assures sustained brand re-purchase and profitable sales growth. The discount vehicle delivers multiple impacts to the consumer target resulting from many purchase opportunities during the year. Such continuity benefits the manufacturer by providing the foundation for consumer retention, giving the consumer the benefit of preferred status and multiple assured discounts, and benefiting the retailer by the store traffic of high volume patrons.

Although only certain embodiments of the present Invention have been expressly disclosed, it is, nonetheless, to be broadly construed and not to be limited except by the character of the claims appended hereto.

I claim:

1. A method of providing multiple discounts to a retail customer for a service or a product from a supplier which does not sell directly to said retail customer, said method comprising
said supplier issuing a vehicle for multiple discounts on said service or said product, said supplier sending said vehicle to said retail customer, said customer presenting said vehicle to a retail establishment,
said retail establishment reading said vehicle, crediting said retail customer with said discount, entering said discount into a retailer payment system which pays at least a portion of said discount to said retail establishment.

2. The method of claim 1 wherein said vehicle is a value card, having ability to retain data relating to said discounts.

3. The method of claim 1 wherein said vehicle is a coupon kit, said coupon kit comprising a plurality of discount coupons, all issued by one said supplier and directed to a single brand of said supplier's service or product.

17. The value card of claim 16 wherein said value card has no time limitations for its use.

18. The value card of claim 16 wherein said value card contains a plurality of discounts on said service or product.

19. The value card of claim 16 containing identification of said retail customer whereby said supplier can relate said retail customer to relevant data about said retail customer.

20. A coupon kit comprising a plurality of discount coupons, all issued by one supplier and directed to a single brand of a service or product originating with said supplier.

21. The coupon kit of claim 20 wherein said coupons are valid without time limitation.

22. The coupon kit of claim 20 wherein said coupons are valid at spaced apart time intervals.

23. The coupon kit of claim 20 wherein said coupons are valid only for a limited period of time.
